(19) United States
(12) Patent Application Publication
(10) Pub. No.: US 2014/0262262 A1
(43) Pub. Date: Sep. 18, 2014

(54) Compositions and Methods for the Controlled Release of Active Ingredients

(71) Applicant: Landec Corporation, Menlo Park, CA (US)

(72) Inventors: Qiang Zheng, Palo Alto, CA (US); Damian Hajduk, San Jose, CA (US); Steven P. Bitler, Menlo Park, CA (US)

(73) Assignee: Landec Corporation, Menlo Park, CA (US)

(21) Appl. No.: 14/210,149

(22) Filed: Mar. 13, 2014

Related U.S. Application Data
(60) Provisional application No. 61/778,819, filed on Mar. 13, 2013.

(51) Int. Cl. C09K 8/588; C09K 8/80

(52) U.S. Cl. CPC C09K 8/588; C09K 8/80; C09K 2208/06
USPC 166/280.1; 507/224; 507/202; 507/219; 428/402

(57) ABSTRACT

This invention discloses articles, in the form of particles to small granules to macro sized objects, capable of the controlled release of active ingredients (AI) from a mixture as a solid solution, a matrix or an encapsulated system containing AI and one or more of polymers, additives and/or carriers. The invention also covers additional surface coatings on those articles to further reduce the rate of release of AI. Finally, methods for producing these articles and treating the oil field well and other segments of the oil industry, for example piping, storage tank, and refinery locations, are introduced. The claimed articles can be used as is or mixed with other oil filed components or system, for example proppant fluid, in oil field applications.

### CROSS-REFERENCE TO RELATED APPLICATION

This application claims the benefit of U.S. Provisional Application No. 61/778,819, filed Mar. 13, 2013.

### FIELD OF THE INVENTION

This invention relates to methods and compositions for the controlled release of active ingredients, including as related to oil field applications.

### BACKGROUND OF THE INVENTION

In view of the exhaustion of oil reserves, the greatest challenge to petroleum industry is the ability to provide this energy source and to supply in the future. Many investments have been made in the search for new reserves and to improve current techniques of oil recovery.

Oil and gas hydrocarbons are naturally occurring in some subterranean formations. Subterranean formations that contain oil or gas are called reservoirs. The reservoirs may be located under land or offshore.

In order to produce oil or gas, a well is drilled into a subterranean formation, which may be a reservoir or adjacent to a reservoir. As used herein, a well includes at least one wellbore drilled into the earth. As used herein, the term “wellbore” refers to the wellbore itself, including a cased portion of the well and any openhole or uncased portion of the well.

Various types of treatments are commonly performed on a well or subterranean formation. For example, stimulation is a type of treatment performed on a well or subterranean formation to restore or enhance the productivity of oil and gas from the well or subterranean formation. Stimulation treatments fall into two main groups; hydraulic fracturing and matrix treatments. Fracturing treatments are performed above the fracture pressure of the subterranean formation to create or extend a highly-permeable flow path between the formation and the wellbore. Other types of treatments include, for example, controlling excessive water production and sand control.

A well or subterranean formation is normally treated with a treatment fluid. As used herein, a “treatment fluid” is a fluid used to resolve a specific condition of a wellbore or subterranean formation. As used herein, a “treatment fluid” also means the specific composition of a fluid at the time the fluid is being introduced into a wellbore. A treatment fluid is typically adapted to be used to resolve a specific purpose, such as stimulation, isolation, or control of reservoir gas or water. The word “treatment” in the term “treatment fluid” does not necessarily imply any particular action by the fluid. As used herein, a “fluid” is a continuous amorphous substance that tends to flow and to conform to the outline of its container as a liquid or a gas when tested at a temperature of 77° F. (25° C.) and a pressure of one atmosphere (101 kPa). In addition, as used herein, a “fluid” should be pumpable when the fluid is introduced into the subterranean formation. As used herein, a “fluid” can be a slurry, which is a suspension of insoluble particles, hi addition, as used herein, a “fluid” can be an emulsion. A treatment fluid can include a gas for foaming the fluid.

“Hydraulic fracturing,” sometimes simply referred to as “fracturing,” is a common stimulation treatment. A treatment fluid adapted for this purpose is sometimes referred to as a “fracturing fluid.” The fracturing fluid is pumped at a sufficiently high flow rate and pressure into the wellbore and into the subterranean formation to create or enhance a fracture in the subterranean formation. Creating a fracture means making a new fracture in the formation. Enhancing a fracture means enlarging a pre-existing fracture in the formation.

A “frac pump” is used for hydraulic fracturing. A frac pump is a high-pressure, high-volume pump. Typically, a frac pump is a positive-displacement reciprocating pump. The structure of such a pump is resistant to the effects of pumping abrasive fluids, and the pump is constructed of materials that are resistant, but not impervious, to the effects of pumping corrosive fluids. Abrasive fluids include hard, insoluble particulates, such as sand, and corrosive fluids include, for example, acids. The fracturing fluid may be pumped down into the wellbore at high rates and pressures, for example, at a flow rate in excess of 50 barrels per minute (2,100 U.S. gallons (7.9 m⁽³⁾) per minute) at a pressure in excess of 5,000 to 10,000 pounds per square inch (“psi”) (34-69 MPa).

A newly-created or extended fracture will tend to close together after the pumping of the fracturing fluid is stopped. To prevent the fracture from closing, a material must be placed in the fracture to keep the fracture propped open. A material used for this purpose is referred to as a “proppant.”

The proppant is in the form of a solid particulate, which can be suspended in the fracturing fluid, carried downhole, and deposited in the fracture as a “proppant pack.” The proppant pack props the fracture in an open condition while allowing fluid flow through the permeability of the pack. A particulate for use as a proppant is selected based on the characteristics of size range, crush strength, and insolubility. Appropriate sizes of particulate for use as a proppant are typically in the range from about 8 to about 100 U.S. Standard Mesh. In a preferred embodiment of the invention, the proppant has a particulate size distribution range such that at least 90% of the proppant has a size of 0.0625 mm to 0.6 mm. For a proppant material that crushes under closure stress, the proppant preferably has an API crush strength of at least 4,000 psi (28 MPa) closure stress based on 10% crush fines. This performance is that of a medium crush-strength proppant, whereas a very high crush-strength proppant would be 10,000 psi (69 MPa). Suitable proppant materials include, but are not limited to, sand, ground nut shells or fruit pits, sintered bauxite, glass, plastics, ceramic materials, processed wood, resin coated sand or ground nut shells or fruit pits or other composites and any combination thereof in any proportion.

Several methods have been developed to increase the oil recovery from the reservoir, such as water injection. With such water injection, a number of opportunities and problems arise, such as biofouling, corrosion, scale deposition, and foaming. There is a need for delivery of effective treatment of potential problems, treatments that can improve or enhance the efficiency of oil field production, stimulation and completion of the oil extraction process, and the delivery of other compositions that may provide advantages. There is a further need to provide sustained release over a period of time. The embodiments herein address these and well as other needs.

U.S. Pat. Nos. 7,615,516, 7,377,968, 7,244,693, 7,196,040, 7,135,440, 6,831,116, 6,326,335, 6,255,367, 5,922,652, 5,866,151, 5,789,350, 5,698,002, 5,164,096, 5,120,349, 5,073,276, 4,986,354, 4,835,234, 4,830,855, 4,738,897, 4,588,640, 4,585,482, 4,552,591, 4,518,509, and 4,272,398, as well as US Published Application Nos. 20060124302, 20100307744, 20110073802, 20110237465, European Application No. EP 0954965, and International Application No. PCT/GB01/02482 provide background information useful to understand or in combination with the embodiments herein. These patents and applications are hereby incorporated by reference in their entirety.

### SUMMARY

The embodiments disclosed herein relate to articles, particles or compositions (which are used interchangeably, herein, except where differences are noted) for releasing active ingredients into a downhole fluid environment in a well and similar oil field applications.

An embodiment comprises a polymeric chemical release composition containing an active ingredients, fillers and carriers for the release of the active ingredient, preferably the sustained release of the active ingredient, into the wellbore and wellcore conduits of an oil or gas producing well or a water injection well. The composition may be used to provide such controlled and/or sustained release of active ingredient in the rathole of a well for the designed purpose, for example, to control biofouling and bacterial growth through release of a biocide.

A preferred embodiment is a thermoset composition formed into a particle with the size ranging from 0.1 microns to larger than 6 inches, comprising:

(a) a thermoset polymer at 10-95 parts by weight, wherein the polymer includes, but is not limited to, polyurethane, polyepoxide (epoxy), poly(meth)acrylates;
(b) an active ingredient at 5-70 parts by weight, wherein the active ingredient is one or more ingredients selected from the group comprising biocide, wax inhibitor, corrosion inhibitor, oxygen scavenger, scale remover/inhibitor, surfactant, catalyst and foaming/de-foaming agents;
(c) a filler at 0-50 parts by weight, wherein the filler is one or more selected from the group comprising mineral materials, such as talc, clay, gypsum, calcite, fluorite, quartz, and corundum;
(d) a carrier at 0-99 parts by weight, wherein the carrier is a mineral or charcoal with a size of at least 75 microns.

The particle may be coated with a coating from about 10 to about 750 microns thick. The coating may retard release, facilitate hold, or be designed to provide a desired release profile for the particular application. For example, it may be desirable to have an initial fast release of an active ingredient in the coating, followed by a slow release from the particle. The coating may be of the same or similar composition as the particle. The coating may also be applied for handling purposes.

The particle may be prepared by

i) in-situ suspension polymerization;

ii) in-situ casting;

iii) mixing/blending the active ingredients and thermoplastic polymers;

iv) followed by light cross-linking via extrusion at elevated temperature; and

v) optionally, crushing/grinding of the products.

The particles are designed for oil field treatment, where the particles may be mixed into a fluid and introduced into a well bore, pipe or rat hole location. The particles may be introduced with the proppant or separately. Synergies may exist by designing the particle to contain the same carrier material as the proppant and to have a similar size.

The active ingredient may be soluble, partially soluble, or insoluble in the water and/or polymer based on the need. The active ingredient composition may be coated on a particle or the particle itself may be coated with a material that offers beneficial properties, such as a hardener, a hydrophobic coating, a hydrophilic coating, and the like. The coating may be crosslinked, partially crosslinked, or not crosslinked. The coating may be applied by a spray or dip method, with or without a solvent. The coating may additionally be cured, for example, thermally or with radiation.

Preferred polymers include polymers or copolymers wherein at least one polymer is selected from the group consisting of polyurethanes, poly(meth)acrylates, polyethylene, polypropylene, polystyrene, polyvinyl chloride, polyethylene terephthalate, polyhydroxyalkanoate, polycaprolactone, derivatives, and the like.

The embodiments herein preferably contain an active ingredient. Examples of active ingredients are biocides, wax inhibitors, corrosion inhibitors, oxygen scavengers, scale removers and inhibitors, surfactants, catalysts, and foaming/de-foaming agents.

The embodiments herein preferably contain at least one filler. Examples of suitable fillers include talc, clay, gypsum, calcite, fluorite, quartz, and corundum. The fillers have a preferred size of 15 microns or less, for example 10 microns or less, or 5 microns or less. The embodiments herein also preferably contain at least one carrier. Examples of suitable carriers are minerals, such as talc, clay, gypsum, calcite, fluorite, quartz, and corundum, or charcoal, where the carrier has a preferred size of more than 75 microns, for example, more than 100 microns or more than 150 microns.

The particle compositions herein may be combined with a proppant or a proppant may be coated with the compositions herein. In some embodiments the proppant is a different material than the carrier. In other embodiments the proppant and carrier are the same material.

One preferred composition includes an epoxy resin and hardener, an active ingredient, a filler, and optionally, a coating. The active ingredient is from about 10 to about 30 percent by weight and the filler is at least about 6 percent by weight. The composition may be in the form of a particle from about 12 to about 40 mesh size, for example about 20 to about 30 mesh size. Alternatively, the particles may be the same size as preferred proppants for the application.

Another embodiment herein comprises a thermoplastic composition with one or more thermoset polymers at 10-95 parts by weight; one or more active ingredients at 5-70 parts by weight; one or more fillers at 0-50 parts by weight; and one or more carriers at 0-99 parts by weight.

As previously noted, the embodiments herein may be formed into a particle, which optionally may be coated with the same or other embodiments disclosed herein or the like, and the embodiments may also be coated proppants.

### BRIEF DESCRIPTION OF THE DRAWINGS

FIG. 1 is a chart demonstrating the effect of six different curing agents with DER 330 (release test in DI water at 60° C., 33% JAQ).

FIG. 2 is a chart demonstrating the effect of clay types in DER™ 330/Ancamide 351A epoxy (release test in DI water at 60° C., 33% JAQ, 6% clay).

FIG. 3 is a chart demonstrating the effect of six different curing agents with DER™ 331 (release test in DI water at 60° C., 33% JAQ).

FIG. 4 is a chart demonstrating the effect of thermoset film thickness on release rate (release test in DI water at 60° C., 33% JAQ).

FIG. 5 is a chart demonstrating the effect of JAQ loading on release rate from poly(UA700) (release test in DI water at 60° C.; 10, 20 and 30% JAQ).

FIG. 6 is a chart demonstrating the effect of JAQ loading on release rate from poly(UA700/AA) (release test in DI water at 60° C.; 10, 20 and 30% JAQ).

### DETAILED DESCRIPTION

In the Summary of the Invention above and in the Detailed Description of the Invention, the Examples, and the Claims below, reference is made to particular features (including method steps) of the invention. It is to be understood that the disclosure of the invention in this specification includes all appropriate combinations of such particular features. For example, where a particular feature is disclosed in the context of a particular aspect or embodiment of the invention, or a particular claim, that feature can also be used, to the extent appropriate, in combination with and/or in the context of other particular aspects and embodiments of the invention, and in the invention generally.

The term “comprises” and grammatical equivalents thereof are used herein to mean that other elements (i.e. components, ingredients, steps etc.) are optionally present. For example, a structure “comprising” (or “which comprises”) components A, B and C can contain only components A, B and C, or can contain not only components A, B and C but also one or more other components.

The terms “a”, “an” and “the” before an item are used herein to mean that there can be a single such item or two or more such items, unless the context makes this impossible.

This invention discloses articles, in the form of particulate to small granules to macro sized objects, capable of the controlled release of one or more active ingredients (“AI”) from a mixture as a solid solution, a matrix or an encapsulated system containing AI and one or more of polymers, fillers, carriers or other materials or forms. A solid solution is a mixture in which all the components are miscible at n the molecular level and there is no phase separation. A matrix system, in which at least one of the components in the mixture is not miscible or partially miscible with other components, is a uniform mixture where the insoluble component is evenly distributed in continuous polymer phase. The encapsulation system is an AI rich core coated with a polymer barrier with the desired thickness. The AI core can be AI itself, a solid solution or a matrix system.

Polymers, Active Ingredient and the Form of Products

Polymers obtained from polyurethane, polyepoxide (epoxy), poly(meth) acrylates, polyethylene, polypropylene, polystyrene, polyvinyl chloride, polyethylene terephthalate, polyhydroxyalkanoate, polycaprolactone, along with their copolymers, can be used as in controlled release of AI. Under the harsh use conditions, such as high temperature and high pressure, cross linking in the polymers provides benefit to extend to release period. Polyurethane, polyepoxide (epoxy) and poly(meth)acrylates are the preferred choice for the crosslinked system due in part to ready raw material availability and reasonable cost.

AI can be biocide, wax inhibitor, corrosion inhibitor, oxygen scavenger, scale remover/inhibitor, surfactant, catalyst, and foaming/de-foaming agents to ensure flow and protect the equipment for oil field applications.

Depending upon the application, the form of the products can range from particulate to small granule of less than 2 mm to macro scale articles of multiple inches. In general, the amount of burst and the overall release rate increase with the decrease of size of the particles. When dealing with small granules of 50-800 micron under high temperature and high pressure release condition, additional measures may be needed to further reduce the undesired burst as well as the release rate of AI. Those measures include filler, carrier, extra coating and ionic or covalently bound AI to the polymer backbone or other additives.

Fillers

Additional ways to slow down the release rate involve the use of additives in the controlled release mixture. These additives are selected from, but not limited to, activated carbon or mineral materials as fillers, such as talc, clay, gypsum, calcite, fluorite, quartz, corundum in the form of fine particles of less than 75 micron (200 mesh). The fillers can form a matrix system in the polymer/AI mixture. The preferred ones are those with high surface area and/or functional sites to interact with AI. In one embodiment, selected fillers at 6% by weight in an epoxy system can reduce the release rate of AI at 60° C. in DI water.

Carriers

When exposed to high temperature and high pressure, certain polymers may lose mechanical strength and physically deform to an undesired shape/size so that the previously expected release profile is altered in a negative way. The disclosed carriers are high surface area materials and can be selected from, but are not limited to, active carbon and minerals, which can be filled and/or coated with the desired mixtures of polymer, AI, or filler. The inherent mechanical strength of the carrier is expected improve the integrity of the product, especially when exposed to harsh condition such as high temperature and high pressure. The size is larger than the filler. The preferred ones are those with high surface area and/or functional sites to potentially interact with AI. The carriers can be the same or different material from that currently used as a proppant component.

Coating

Spray and/or dip coating methods can be used to apply a polymer coating onto articles in order to reduce the burst and/or release rate. For particles with small size granule or bead of less than 2 mm, a polymer coating barrier may be helpful to reduce the burst and release rate through various scalable methods including spray, fluid bed, etc. The coating materials can be selected from the polymers suitable in the mixture described above.

Method of Preparing Samples

Methods to prepare the disclosed articles depend on the requirement of size and shape of the articles suitable for specific applications.

Casting

Casting in a mold is suitable for preparing large bulk articles. In general, one can mix the AI with proper monomers/additives, fill the mixture into a mold and let the mixture cure at the desired temperature for a period of time. Both thermal and radiation cure are suitable. The polymers in the resulting articles can be either cross linked or not cross linked. One can also mix the AI into thermoplastic polymers at elevated temperature in an extruder and inject the mixture into a mold or chop the extrude stream into discrete pellets. Reactive injection molding (RIM) can be used to prepare mixtures of JAQ Powdered Quat, such as the Quaternary Ammonium Compound from Lonza (dimethyl benzyl ammonium chloride), in monomers suitable for polyurethane. All these articles can be used as is or further processed into smaller size. In on embodiment, the monomers are epoxy resins, while the model AI is JAQ powdered quat. The JAQ powdered quat can be premixed with either part of the epoxy resins at 65-75° C. The other part of the epoxy resin is added to and mixed with the resulting cooling mixture. After filling the mold of the desired shape, let the mixture cure for at least 2-3 days before de-molding. In another embodiment, the JAQ was mixed with acrylic monomers and necessary photo and/or thermo initiator at room temperature. The obtained mixture is pour into a mold and undergoes photo/thermal polymerization.

Extrusion

Extrusion is also suitable for making. One can also mix the AI into thermoplastic polymers at elevated temperature in an extruder to prepare large pellets and bulk sample.

Radiation Cure

Radiation cure can be used to cast bulk samples as well as to make coating.

Crushing/Grinding

The cured bulk samples from a solid solution or matrix system of larges beads or chunks prepared from above can always be crushed, ground and sieved into small granules in the range of 50 micron to a few millimeters range. For a matrix system, the down side of this process is the exposure of bare AI at the fresh surface, leading to possible undesired high burst.

Suspension

Suspension methods are ideal for the preparation of small particles/bead of less than a few millimeters. In the 1st embodiment, AI can be premixed into a solution thermoplastic polymer, along with necessary fillers, carriers and other additives. The resulting mixture can be fed into an aqueous phase to form particles/beads. Here, the aqueous phase may need to be conditioned by the use of proper additives for the desired size, stabilization of the formed particles as well as for the preventing or minimizing of the undesired leach of AI into the aqueous phase. The additives include thickeners, surfactants, biosurfactants (e.g., derivatives of alcaligenes) and salts. AI can be one of the additives too to saturate the aqueous solution so that a minimal amount or none of AI in the mixture can be leached out. The solvent if used still trapped in the product can be removed either at the end of the process or after the particles/beads are collected.

In another embodiment, AI can be mixed with acrylic monomers, along with necessary fillers, carriers, initiators, other additives and solvents. The obtained mixture is fed into an aqueous phase to form particles/beads via a typical suspension polymerization at elevated temperature. Here, the aqueous phase may also need to be conditioned by the use of proper additives for the desired size, stabilization of the formed particles as well as for the preventing or minimizing of the undesired leach of AI into aqueous phase. The additives include thickeners, surfactants and salts. AI can be one of the additives too to saturate aqueous solution so that minimal or none of AI in the mixture can be leached out. In this case, the polymers in resulting in-situ cured particles/beads can either a thermoset or thermoplastic system.

In another embodiment, a mixture of AI and epoxy resins, with or without necessary fillers and carriers, is dispersed in an aqueous phase to form desired particle size and cured at desired combination of time and temperature for the optimized combination of cure rate and desired release performance. Solvent may be required to enable the process. Here, the aqueous phase may also need to be conditioned by the use of proper additives for the desired size, stabilization of the formed particles as well as for the preventing or minimizing of the undesired leach of AI into the aqueous phase. The additives include thickeners, surfactants and salts. AI can be one of the additives too to saturate aqueous solution so that minimal or none of AI in the mixture can be leached out. Also need to ensure saturation of any part of the epoxy resins in aqueous phase, if needed, to ensure the stoichiometry of epoxy resins in the partials/beads. If solvent is used, the solvent still trapped in the product can be removed either at the end of process or after the particles/beads are collected.

In another embodiment, a non-aqueous phase can partially or completely replace the water described in the previous embodiments.

In another embodiment one or more side chain crystalline polymers (SCC polymers) may be used in a composition with active ingredients, fillers, carriers and, optionally, a coating such as the embodiments disclosed herein, and the like.

For methods to prepare embodiments herein, ¼″ to 1″ cylinders may be used in such preparation.

Coating

Dip coating may be preferred with large size particles, though spray or fluid bed coating techniques may be used.

Spray and/or fluid bed coating may be preferred on granular or bead particles. Preferred polymers coatings are either thermoplastics or thermoset.

### Examples 1 to 6

Thermoset composition for examples 1 to 6 is listed in Table 1. General procedure starts with mixing the DER™ 330 epoxy resin with JAQ at 80° C. After cooling, the curing agent is mixed into the mixture, leading to a thick flowable liquid or soft paste which can fill a silicone mold cavity. The diameter of the cavity has a cylinder shape at 0.5 inch OD and 0.5 inch height. After curing for at least for 3 days at room temperature, the cylinder shaped samples can subject to release tests in DI water at 60° C. FIG. 1 shows the release profiles from those formulations.

TABLE 1
Formulation of thermoset for examples 1-6 (33% JAQ)

| | | Curing aging | | DER 330 | JAQ |
|---|---|---|---|---|---|
| Example | Formulation | | wt | wt | |
| # | ID | Name | (gram) | (gram) | |
| 1 | 371-129-1 | DEH 24 | 0.7 | 5.3 | 3.0 |
| 2 | 371-129-2 | DEH 26 | 0.8 | 5.2 | 3.0 |
| 3 | 371-129-3 | DEH 29 | 0.8 | 5.2 | 3.0 |
| 4 | 371-129-4 | Ancamide 351A | 2.2 | 3.8 | 3.0 |
| 5 | 371-129-5 | Ancamide 261A | 2.4 | 3.6 | 3.0 |
| 6 | 371-129-6 | Ancamide 221 | 3.0 | 3.0 | 3.0 |

### Examples 7 to 12

Thermoset composition for examples 7 to 12 is listed in Table 2. General procedure starts with mixing the Ancamide 351A epoxy resin with JAQ at 80° C. After cooling, the DER™ 330 epoxy is mixed into the mixture, followed by clay, leading to a soft paste which can fill a silicone mold cavity. The diameter of the cavity has a cylinder shape at 0.5 inch OD and 0.5 inch height. After curing for at least for 3 days at room temperature, the cylinder shaped samples can subject to release tests in DI water at 60° C. FIG. 2 shows the release profiles from those formulations.

TABLE 2
Formulation of thermoset for examples 7-12 (33% JAQ)

| | | | | Ancamide | | |
|---|---|---|---|---|---|---|
| | | Clay | | 351A | DER330 | JAQ |
| Example # | Formulation ID | Name | % by wt | % by wt | | |
| 7 | 371-141-1 | Bentone HC | 6.0 | 21.7 | 38.9 | 33.3 |
| 8 | 371-141-2 | Bentone SD2 | 6.0 | 21.7 | 38.9 | 33.3 |
| 9 | 371-141-3 | Bentone SD3 | 6.0 | 21.7 | 38.9 | 33.3 |
| 10 | 371-141-4 | Bentone 34 | 6.0 | 21.7 | 38.9 | 33.3 |
| 11 | 371-141-5 | Wyo bentonite | 6.0 | 21.7 | 38.9 | 33.3 |
| | | puregold gel | | | | |
| 12 | 371-141-6 | Black Hill Bond | 6.0 | 21.7 | 38.9 | 33.3 |

### Examples 13 to 18

Thermoset composition for examples 13 to 18 is listed in Table 3. General procedure starts with mixing the DER™ 331 epoxy resin with JAQ at 80° C. After cooling, the curing agent is mixed into the mixture, leading to a thick flowable liquid or soft paste which can fill a silicone mold cavity. The diameter of the cavity has a cylinder shape at 0.5 inch OD and 0.5 inch height. After curing for at least for 3 days at room temperature, the cylinder shaped samples can subject to release tests in DI water at 60° C. FIG. 1 shows the release profiles from those formulations.

TABLE 3
Formulation of thermoset for examples 13-18 (33% JAQ)

| | | Curing aging | | DER 330 | JAQ |
|---|---|---|---|---|---|
| Example | Formulation | | wt | wt | |
| # | ID | Name | (gram) | (gram) | |
| 13 | 371-129-7 | DEH 24 | 0.7 | 5.3 | 3.0 |
| 14 | 371-129-8 | DEH 26 | 0.8 | 5.2 | 3.0 |
| 15 | 371-129-9 | DEH 29 | 0.8 | 5.2 | 3.0 |
| 16 | 371-129-10 | Ancamide 351A | 2.1 | 3.9 | 3.0 |
| 17 | 371-129-11 | Ancamide 261A | 2.3 | 3.7 | 3.0 |
| 18 | 371-129-12 | Ancamide 221 | 3.0 | 3.0 | 3.0 |

### Example 25

Thermoset composition of example 14 is processed into thin film with 3, 5, 10, 15, 20 and 30 mil thickness by a) mixing the DEH™ 26 resin with JAQ at 80° C., b) after cooling, mixing DER™ 331 into the mixture, leading to a thick flowable liquid, c) casting film between Mylar films using proper stainless steel shims to control the thickness of films. After curing for at least for 3 days at room temperature, the disc shape sample with 9/16 inch OD is made using the arch punch under slight warm temperature (<50° C.). The round film samples can subject to release tests in DI water at 60° C. FIG. 4 shows the release profiles from those formulations.

### Example 26

FIG. 5 is the JAQ release profile from poly(UA700), a thermoplastic polymer, made from Unilin 700 acrylate, which is the etherification product of acrylic acid and Unilin 700 alcohol. The peak melting temperature of poly(UA700) is 108° C. The release samples can be prepared by mixing the JAQ with poly(UA700) at 125° C., poured into a cavity of cylinder shape at OD×L=8×20 mm. After the cast samples cool down and sit overnight, they are ready for release test.

### Example 27

FIG. 6 is the JAQ release profile from poly(UA700/AA), also a thermoplastic polymer, made from Unilin 700 acrylate with 5% by weight of acrylic acid. The peak melting temperature of poly (UA700/AA) is 106° C. The release samples can be cab be made the same way as example 26.

The formulations and concepts herein may be applied in other fields, such as agriculture, personal care, home use and other industrial applications where the concept of using a filler to reduce the release rate of an active ingredient may be preferable.

The foregoing description is included to illustrate the preferred embodiments and is not meant to limit the scope of the invention. To the contrary, other embodiments and variations will become apparent to those skilled in the art from the description and examples herein without departing from the scope of the invention, aspects of which are recited by the claims appended hereto.

1. A particle with the size ranging from 0.1 microns to larger than 6 inches, comprising:
(a) a thermoset polymer at 10-95 parts by weight, wherein the polymer includes, but is not limited to, polyurethane, polyepoxide (epoxy), poly(meth)acrylates;
(b) an active ingredient at 5-70 parts by weight, wherein the active ingredient is one or more ingredients selected from the group comprising biocide, wax inhibitor, corrosion inhibitor, oxygen scavenger, scale remover/inhibitor, surfactant, catalyst and foaming/de-foaming agents;
(c) a filler at 0-50 parts by weight, wherein the filler is one or more selected from the group comprising mineral materials, such as talc, clay, gypsum, calcite, fluorite, quartz, and corundum;
(d) a carrier at 0-99 parts by weight, wherein the carrier is a mineral or charcoal with a size of at least 75 microns.

2. A method of preparing the particle of claim 1 wherein the particle is prepared by
vi) in-situ suspension polymerization;
vii) in-situ casting;
viii) mixing/blending the active ingredients and thermoplastic polymers;
ix) followed by light cross-linking via extrusion at elevated temperature; and
x) optionally, crushing/grinding of the products.

3. A thermoplastic composition comprising:
(a) one or more thermoset polymers at 10-95 parts by weight;
(b) one or more active ingredients at 5-70 parts by weight;
(c) one or more fillers at 0-50 parts by weight; and
(d) one or more carriers at 0-99 parts by weight, wherein with composition is formed into particles ranging from about 0.1 microns to about 6 inches in size.

4. The composition of claim 3 wherein the particle has a coating that is from about 10 to about 750 microns thick.

5. A method of preparing the particles of claim 3, wherein the particles are prepared by;
i) in-situ suspension polymerization;
ii) in-situ casting;
iii) mixing/blending the active ingredients and thermoplastic polymers;
iv) followed by light cross-linking via extrusion at elevated temperature; and
v) optionally, crushing/grinding of the products.

6. A method of oil field treatment, where the particle of claim 1 is mixed into a fluid and introduced into a well bore, pipe or rat hole location, wherein the article is introduced with a proppant.

7. A method of oil field treatment, where the particle of claim 1 is mixed into a fluid and introduced into a well bore, pipe or rat hole location, wherein the particle is introduced without a proppant.

8. The particle of claim 1, wherein the filler is in the form fine particles of 15 microns or less.

9. The particle of claim 1, wherein the particle is combined with a proppant and the proppant is a different material as the carrier used in the particle.

10. The particle of claim 1, wherein the particle is combined with a proppant and the proppant is the same material as the carrier used in the particle.

11. The particle of claim 1, wherein the particle is combined with a proppant and the particle and proppant are substantially the same size.

12. The particle of claim 1 wherein the active ingredient is at least partially soluble in the polymer.

13. The particle of claim 1, wherein the active ingredient is insoluble in the polymer and soluble in water.

14. The particle of claim 1, wherein the coating is thermally cured.

15. The particle of claim 1, wherein the coating is cured by radiation.

16. The composition of claim 3, wherein at least one polymer is selected from the group consisting of polyurethanes, poly(meth)acrylates, polyethylene, polypropylene, polystyrene, polyvinyl chloride, polyethylene terephthalate, polyhydroxyalkanoate, polycaprolactone, and derivatives of such polymers.

17. The composition of claim 3, wherein at least one active ingredient is selected from the group consisting of a biocide, wax inhibitor, corrosion inhibitor, oxygen scavenger, scale remover/inhibitor, surfactant, catalyst, and foaming/de-foaming agents.

18. The composition of claim 3, wherein at least one carrier is a mineral or charcoal with the size of more than 75 microns.

19. The composition of claim 3, wherein the composition is combined with a proppant and wherein the proppant is the same material as the carrier.

20. A thermoplastic composition comprising:
(a) one or more thermoset polymers at 10-95 parts by weight;
(b) one or more active ingredients at 5-70 parts by weight;
(c) one or more fillers at 0-50 parts by weight; and
(d) one or more carriers at 0-99 parts by weight.
